(19) United States
(12) Patent Application Publication
(10) Pub. No.: US 2025/0040584 A1
(43) Pub. Date: Feb. 6, 2025

(54) DEVICE OR METHOD FOR PRODUCING A FOOD PRODUCT FROM A PORTION OF FOOD

(71) Applicant: Eberhardt GmbH, Lichtenau (DE)

(72) Inventors: Rainer Eberhardt, Lichtenau (DE); Ralf Eberhardt, Lichtenau (DE)

(21) Appl. No.: 18/789,876

(22) Filed: Jul. 31, 2024

(30) Foreign Application Priority Data
Aug. 4, 2023 (EP) 23189751.3

(51) Int. Cl. A23P 30/10

(52) U.S. Cl. CPC A23P 30/10

(57) ABSTRACT

The invention relates to a device or a method for producing a food product from a portion of food. The device comprises a housing which is open on at least one side for receiving a plurality of separate mold containers which are arranged directly on top of one another in at least one stack and can each be filled with a portion of food. The device furthermore comprises at least one drive arranged in a bottom region of the housing for driving a pressure die which is mounted in the housing so as to be slidable in the direction of the stack for exerting a pressing force upon the stack and a telescopic guide rail arranged between a cover of the housing and the pressure die for guiding the pressure die in the housing.

### CROSS-REFERENCE TO RELATED APPLICATIONS

The present application claims priority to European Patent Application No. 23189751.3, filed Aug. 4, 2023, the disclosure of which is incorporated by reference.

### FIELD OF THE INVENTION

The present invention relates to a device and a method for producing a food product from a portion of food.

### BACKGROUND OF THE INVENTION

Devices or methods for producing a food product are known from prior art.

For example, DE 10-2010-031-011 A1 teaches a housing that is open on all sides for receiving mold containers that are stacked on top of one another and filled with meat products. A pressure die operated by a hand-operated spindle drive is pressed onto the mold containers from above for exerting a pressing force thereupon. A disadvantage of this device is that manual adjustment of the spindle drive is uneconomical. In particular, if the housing has been placed in a chamber in which heat or smoke treatment is conducted, it is necessary to interrupt the production process in order to manually adjust the spindle drive. This process interruption can have a detrimental effect on the quality of the food product produced. Another disadvantage is that only a limited stroke of the pressure die is possible with the spindle drive.

DE 100-44-100 A1 teaches a closed pressing container with several press chambers for receiving meat products. The pressing chambers are separated from each other by telescopic channels. A pressure plate driven by a pneumatic cylinder exerts a pressing force from below in the direction of the pressing chambers. The disadvantage of this device is that, due to the closed pressing container, the meat products can only be heat treated to a limited extent, for example, not smoked. Another disadvantage is that the pressure die can easily tilt sideways if the meat products are compressed to different degrees due to deviations in the composition, e.g. the ratio of water to fat, when a pressing force is applied. This can lead to damage to the pressing container and/or the meat products.

Based on known prior art, the technical problem to be solved is to provide a device or a method for producing a food product that largely overcomes the disadvantages of prior art. The object is to enable simple and efficient production of a food product from a portion of food. Optionally, it is to be made possible to subject the portion of food to heat treatment in a simple and efficient manner. Ideally, the accuracy and/or quality of the food product produced is to be improved.

### SUMMARY OF THE INVENTION

The foregoing object is satisfied according to the invention by a device or a method for producing a food product from a portion of food.

In one embodiment, a device for producing a food product from a portion of food is disclosed. The device comprises a housing which is open on at least one side for receiving a plurality of separate mold containers which are arranged directly on top of one another in at least one stack and can each be filled with a portion of food. The device further comprises at least one drive arranged in a bottom region of the housing for driving a pressure die which is mounted in the housing so as to be slidable in the direction of the stack for exerting a pressing force upon the stack. The device further comprises at least one telescopic guide rail arranged between a cover of the housing and the pressure die for guiding the pressure die in the housing. This allows food products to be subjected to heat treatment in a simple manner. Optionally, the device can enable economical work that meets industrial requirements. Ideally, the accuracy of the food product produced, in particular its shape, can be improved. Optionally, rejects of incorrectly produced food products can be reduced.

The food product and/or portion of food can comprise meat and/or fish. Optionally, the food product and/or the portion of food can comprise no meat and/or fish, in particular be vegetarian or vegan. For example, the food product and/or portion of food can comprise a meat substitute or vegetables. The food product can be suitable for human or animal consumption.

The heat treatment can comprise a baking, frying, cooking and/or smoking process. The heat treatment can comprise heating and/or optionally cooling. The portion of food can be heat treated in a temperature range of −30° C. to +90° C. The device including the drive is suitable for use across this temperature range—i.e. across the entire temperature range from—30° C. to +90° C., the drive and the device as a whole remain corrosion-resistant, dimensionally stable, operational, and/or maintain their functionality.

By having the housing be open on at least one side, it can be ensured that the portion of food receives a uniform heat or smoke treatment. The housing and/or the guide rail can comprise or be made of stainless steel, which can enable the device to be used for foods. Optionally, the guide rail, in particular the rail housing and/or the pullout element, can comprise or be made of plastic material. Ideally, cleaning the housing and/or the guide rail can be facilitated and, ideally, the quality of the food product produced can be improved.

The pressure die can be moved by way of a driving force of the drive. Optionally, several drives, which can in particular be driven synchronously, can be provided. The drive can drive the pressure die such that it transmits the pressing force stepwise or steplessly to the stack. The pressing force can depend upon the portion of food to be processed, in particular its composition. For example, the driving force of the drive can be detected by way of a sensor, for example, a force sensor, and adjusted by way of a control device such that the pressure die generates the desired pressing force. A separate pressing station can be dispensed with by arranging the drive for the pressure die at the device.

The pressure die can be moved between a lower pressure die position and an upper pressure die position. The pressure die can be moved from the lower pressure die position to the upper pressure die position to produce the food products. The lower pressure die position can be dependent upon the drive arranged under the pressure die, in particular its height. The upper pressure die position can be dependent upon the stack, in particular its height at one end of the production process.

Since the mold containers in the housing are stacked directly on top of one another, the pressure exerted by the pressure die upon a top mold container of the stack, which can abut against the cover of the housing, can be transmitted to all mold containers in the stack.

The pressure die can contact the stack, at least in sections, in particular a container base of a lowermost mold container. The pressure die can comprise a rectangular die frame on which a plurality of horizontal die struts is arranged which can be contacted by one or more container bases.

A lowermost mold container of the stack can be positioned directly on the pressure die. Since the housing is open on at least one side, it can be easily and quickly loaded with mold containers, even if the housing is relatively high. The mold containers can be placed in the housing while the pressure die is in the lower pressure die position. Optionally, the pressure die for loading the housing can be moved to any height between the lower pressure die position and the cover of the housing in order to facilitate loading of the housing. As the number of mold containers positioned in the housing increases, the pressure die can be moved in the direction toward the lower pressure die position, which can represent a starting position of the pressure die for the production process, until all mold containers have been placed in the housing.

The stack can comprise only one or several mold containers. The number of mold containers can depend upon a height of the housing, in particular of a rack described hereafter, of the drive, of the pressure die and/or of the mold container. The stack can comprise at least five mold containers, preferably at least ten mold containers. The stack can comprise, for example, 20 mold containers, preferably at most of 15 mold containers. The mold container can comprise a container base, in particular a tray, for receiving the portion of food and a container lid for covering the portion of food. The mold container, in particular the container base and/or the container lid, can comprise recesses, at least in sections, through which air, water, and/or fat can flow. The mold container can be adaptable to the dimensions of the food product to be produced. By applying the pressing force to the mold container, the container lid and container base can shift relative to each other to shape the food product under pressure.

The bottom region of the housing can be a base of the housing. Optionally, the bottom region can be a region that in a vertical direction of the device is at most 20 cm, preferably at most 10 cm, away from the base of the housing. The base of the housing and/or the cover of the housing can comprise recesses, at least in sections, through which air, water, and/or fat can flow. The base and/or the cover can comprise a rectangular frame on which a plurality of horizontal struts is arranged. The base and the cover can each be connected at their corners to vertical longitudinal struts to form a rack. Arranged at the longitudinal struts can be one or more cross struts on two opposite sides of the rack, which can stabilize the rack. Optionally, the cover of the rack can be fastened to the vertical longitudinal struts in a detachable manner in order to be removed, if necessary, for example, for cleaning.

The telescopic guide rail serves to guide, in particular linearly, the pressure die in the housing when it is moved in the housing due to the driving force. Non-uniform movement of the pressure die, in particular lateral tilting or canting in the housing, can be prevented. Optionally, it can be ensured that the pressure die exerts a desired pressing force upon the stack. This can contribute to an almost friction-free and optionally economical process flow.

The guide rail can be fastened to the cover and/or pressure die in a detachable manner. This can be particularly advantageous when cleaning the guide rail and/or the housing.

The guide rail can comprise a rail housing with a pullout element that can slide therein. The rail housing can be connected to the cover of the housing and the pullout element can be connected to the pressure die or vice versa. The pullout element can be moved out of the rail housing or into the rail housing by at most a maximum rail distance. The maximum rail distance can depend upon a length of the pullout element, in particular correspond thereto. In a state in which the pressure die is in the lower pressure die position, the pullout element can be moved out of the rail housing by at most the maximum rail distance. If the pressure die moves from the lower pressure die position to the upper pressure die position by a pressure die distance, then the pullout element can move into the rail housing by this pressure die distance. The pressure die distance can correspond at most to the maximum rail distance. The guide rail, in particular its length, can be sized such that the pressure die distance is at most 95 percent, preferably at most 90 percent, of the maximum rail distance in order to prevent the pressure die from executing a greater motion than the pullout element. The rail housing can have a rail housing inner diameter of at least about 35 mm, preferably at least about 40 mm. The rail housing can have a rail housing inner diameter of at most about 50 mm, preferably at most about 45 mm. The rail housing can have a rail housing wall thickness of at least about one millimeter, preferably at least about two millimeters The rail housing can have a rail housing wall thickness of at most about five millimeters, preferably at most about three millimeters A pullout element outside diameter can be smaller than the rail housing inside diameter. The pullout element can have a pullout element outside diameter of at least about 30 mm, preferably at least about 35 mm. The pullout element can have a pullout element outside diameter of at most about 47 mm, preferably at most about 40 mm. The pullout element can have a pullout element wall thickness of at least about one millimeter, preferably at least about two millimeters. The pullout element can have a pullout element wall thickness of at most about five millimeters, preferably at least about three millimeters. The pullout element can be in engagement with the rail housing by way of a sliding inner tube. The sliding inner tube can comprise or be made of plastic material, in particular polyoxymethylene (POM) and/or polytetrafluoroethylene (PTFE). When the pullout element moves relative to the rail housing, the sliding inner tube, in particular a sliding surface thereof, can slide on a rail housing inner wall. Damage to the pullout element and/or the rail housing can be prevented. Ideally, friction, vibrations, and/or noise between the pullout element and the rail housing can be reduced. The sliding inner tube can be attached to the pullout element, preferably in a detachable manner. For example, the sliding inner tube can be attached to an (internal) thread of the pullout element, for example, with at least one screw. The sliding surface can be at least about 50 mm, preferably at least about 60 mm, long. The sliding surface can be at most about 120 mm, preferably at most about 90 mm, long.

Preferably two or more guide rails are provided. This can improve the guidance of the pressure die and, in particular, largely prevent lateral tilting or canting of the pressure die. If several guide rails are provided, they can be arranged in an m×n matrix. A distance between the guide rails and/or an edge of the housing can depend upon the mold container or stack, in particular upon its width and/or length. In particular, if several stacks are to be arranged next to one another in the housing, the number and/or arrangement of the guide rails can depend upon the number of stacks. One or more guide rails can be arranged, in particular consecutively, between the stacks.

The telescopic guide rail is preferably configured to be seamless. This can improve guidance of the pressure die and, in particular, largely prevent lateral tilting or canting of the pressure die. This can enable uniform sliding of the pullout element in the rail housing. A uniform, in particular almost jerk-free, motion of the pressure die can thus be made possible. Ideally, the quality of the food product produced can be increased.

The telescopic guide rail is preferably configured as a lateral stop for the stack. This can enable easy and accurate positioning of the stack within the housing. In particular when the pressure die is moving, the guide rail can prevent tilting and/or turning of one or more mold containers in the stack. The stack can thus be stabilized in the housing. This can also make it easier to load and empty the housing.

Preferably, the pressure die and/or the telescopic guide rail, in particular a pullout element, can each slide by at least 35 cm, preferably by at least 40 cm, and/or by at most 80 cm, preferably by at most 60 cm. This can ensure that the motion of the pressure die or of the guide rail is sufficiently large to shape the food product. Optionally, this can enable simple loading of the housing, for example, if the pressure die for loading the housing is raised starting from the lower pressure die position. The sliding of the pressure die or the guide rail can depend upon the portion of food to be processed.

The drive preferably comprises a pneumatic lifting cylinder. This can enable moving the pressure die in an easy and efficient manner. The driving force of the drive can be generated in a simple and precise manner and be adjusted, in particular, such that the pressure die exerts a desired pressing force upon the stack. For example, the driving force of the drive can be detected by way of a sensor, for example, a pressure gauge, and adjusted by way of a control device such that the pressure die generates the desired pressing force. Optionally, a pressing force can be generated upon the pressure die that is higher, in particular in comparison to a manual (spindle) drive. During the production process, the resistance of the portion of food to be pressed can decrease, for example, due to water loss. Therefore, it can be desirable to adjust, in particular increase, the pressing force according to this decrease in resistance for producing the desired food product. This control of the pressure die can be implemented in a simple manner using the pneumatic drive. In particular, manual (re-) adjustment of the drive, as is required, for example, with a manually operated spindle drive, can be dispensed with.

The lifting cylinder can be configured as a bellows cylinder. This allows for a resilient, reliable, and ideally inexpensive drive to be realized. The pneumatic drive can have a quick coupling that can be connected to a source of compressed air in a simple manner. This can be particularly advantageous if the housing is to be moved into a processing room in which the heat and/or smoke treatment takes place for producing the food product there. Once the housing has been placed in the processing room, a compressed air hose can be connected to the quick coupling and the drive can thus be supplied with compressed air. This eliminates the need to interrupt the production process for adjusting the drive and, ideally, improves the accuracy and/or quality of the food product produced.

The housing is preferably formed by a rack that is open on several sides, preferably on all sides. This ensures an in particular uniform heat (heating and cooling) and/or smoke treatment of all meat products in the stack.

The housing is preferably configured to receive several stacks arranged next to one another. This allows the number of food products that can be produced simultaneously to be increased. This enables economical production of food products in large batches with equalized shape and quality that meets industrial requirements. The throughput of the device can be increased. The stacks can be aligned relative to each other by way of guide rails. The housing can be configured to receive at least two, preferably at least three, stacks. The housing can be configured to receive at most five, preferably a at most four, stacks.

The housing is preferably movable. This means that the device can easily be moved to the processing space. Economical production of food products can be made possible. The housing can comprise a plurality of, preferably stoppable, rollers which can be arranged at the rack, in particular at the base. The wheels can be foldable.

Optionally, the rack can have at least one receiving device to be movable on conveyor belts or by way of a forklift.

Optionally, the rack can have a gripping device, in particular on the longitudinal struts, for moving the housing.

Optionally, the rack can be stackable. Two or more racks can be stacked on top of one another. Each rack can comprise at least one stacking device for stacking with a second rack.

The invention further relates to a method for producing a food product from a portion of food using a device described above.

The features or explanations described by one of the aspects (device or method) can be transmitted individually or in combination to the other aspects and combined with them.

### BRIEF DESCRIPTION OF THE DRAWINGS

The invention shall be explained hereafter by way of exemplary embodiments, where:

FIG. 1 shows a perspective view of a device for producing a food product according to an embodiment;

FIG. 2a shows a schematic front view of a device for producing a food product according to an embodiment at the beginning of a production process;

FIG. 2b shows a schematic front view of a device for producing a food product according to an embodiment at the end of a production process; and

FIG. 3 shows a schematic view of a guide rail of a device for producing a food product according to an embodiment.

### DETAILED DESCRIPTION OF THE CURRENT EMBODIMENTS

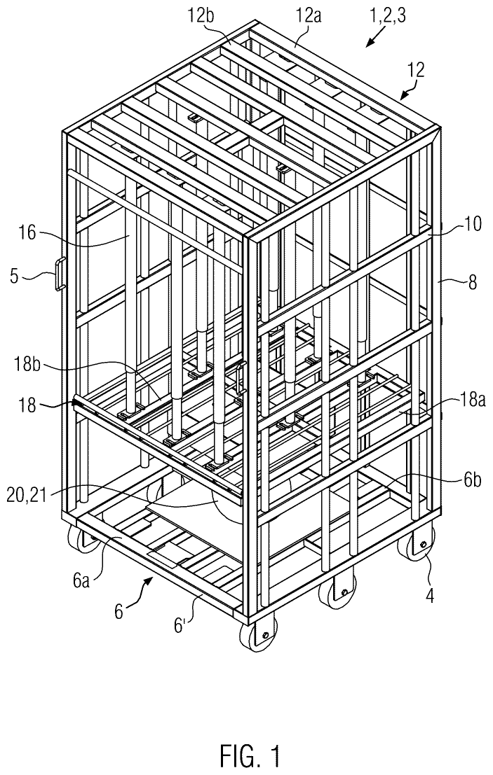

FIG. 1 shows a perspective view of a device 1 for producing a food product from a portion of food according to an embodiment. In the present embodiment, the food product and the portion of food each comprise meat. The food product and/or the portion of food can optionally comprise fish. The food product and/or the portion of food can optionally comprise no meat and/or fish, in particular be vegetarian or vegan. For example, the food product and/or portion of food can comprise a meat substitute or vegetables. The food product can be suitable for human or animal consumption.

Device 1 comprises a housing 2 that is open on all sides and is formed by a rack 3 that is open on all sides and defines a cuboid-shaped cavity. Due to the rack-like open design, smoke and warm/cold air can penetrate into the interior of housing 2 from all sides so that the portions of food introduced into the device are treated uniformly. In addition, water and/or fat can flow through open rack 3. Housing 2 and guide rails 16 described below are made of, for example, or comprise stainless steel which enables device 1 to be used for foods. Guide rails 16, in particular a rail housing 16a and/or a pullout element 16b, can optionally comprise or be made of plastic material. Ideally, cleaning housing 2 and guide rails 16 is made easier and, ideally, the quality of the food products produced is improved.

Housing 2 comprises a base 6′ which is formed by a rectangular frame 6a on which four horizontal struts 6b are arranged. Housing 2 further comprises a cover 12, which is formed by a rectangular cover frame 12a, on which five horizontal cover struts 12b are arranged. Formed between horizontal struts 6b and cover struts 12b are recesses through which air, water, and/or fat can flow. This ensures particularly uniform heat (heating and cooling) and/or smoke treatment of all meat products.

Cover 12 and base 6′ are each connected at their corners to vertical longitudinal struts 8 to form rack 3. Cover 12 is connected to the vertical longitudinal struts 8 so as to be detachable in order to be removed, if necessary, for example, for cleaning. Arranged on longitudinal struts 8 on two opposite sides of rack 3 are three cross struts 10 which stabilize rack 3. Six stoppable rollers 4 are arranged on base 6′ of housing 2 for moving housing 2. A gripping device 5 is arranged on longitudinal struts 8 on a front side of housing 2 in order to move device 1, in particular into a processing room in which the heat and/or smoke treatment takes place.

In the present embodiment, the heat treatment comprises a smoking process at approximately 75° C. The heat treatment can optionally comprise a baking, frying, and/or cooking process. The heat treatment can optionally comprise heating and/or cooling. The portion of food can optionally be heat treated in a temperature range of −30° C. to +90° C.

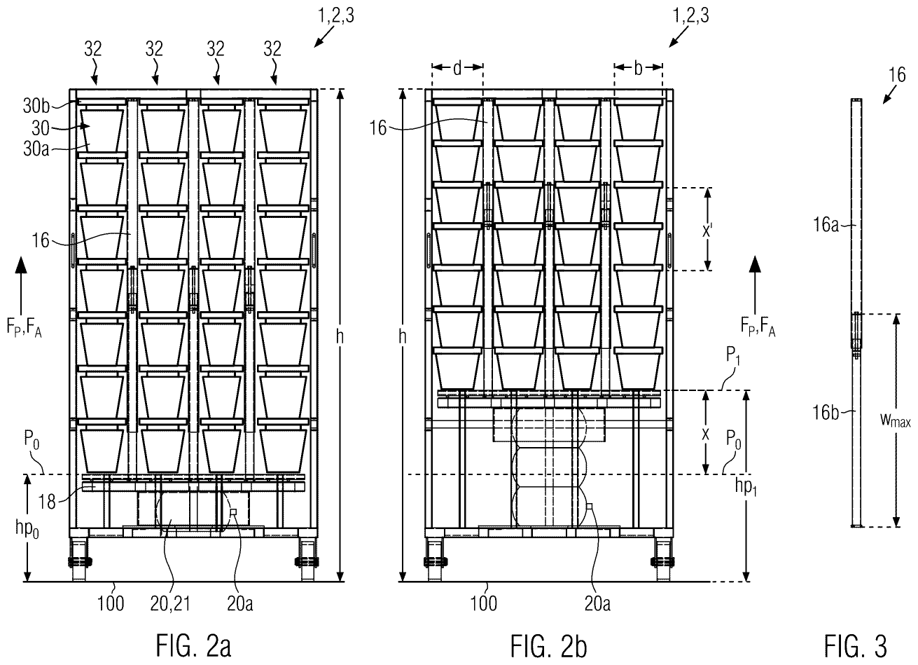

Arranged next to each other in housing 2 are four stacks 32 with separate, i.e. individually manageable mold containers 30 (see FIG. 2a). Each stack 32 comprises seven mold containers 30 stacked directly on top of one another. This means that 28 food products can be produced simultaneously in one production process. The arrangement of several stacks 32 increases the throughput of device 1. This enables economical production of food products in large batches with a balanced shape and quality that meets industrial requirements.

Mold container 30 comprises a container base 30a which is configured as a tray for receiving the portion of food. A container lid 30b is provided for covering the portion of food. If a pressing force F_{P} oriented according to the arrow in FIGS. 2a and 2b acts upon the mold container 30, container lid 30b and container base 30a move relative to one another in order to shape the food product under pressure or under the influence of pressing force F_{P}, respectively (see FIG. 2b).

Stacks 32 are positioned directly on a pressure die 18 which is mounted in housing 2 so as to be slidable in the direction of stack 32 and which is intended to exert pressing force F_{P} upon stacks 32. Pressure die 18 comprises a rectangular die frame 18a on which a plurality of horizontal die struts 18b are arranged which can be contacted by container bases 30b of lowermost mold containers 30 of each stack 32.

In FIG. 2a, device 1 is shown immediately after being loaded when pressure die 18 does not yet exert any pressing force F_{P} upon stacks 32. Device 1 makes it easier to load housing 2 with mold containers 30. This is achieved in that housing 2 is open on all sides so that it can be easily and quickly filled with mold containers 30 even when the overall height h of the device is relatively high, in the present case approximately 200 cm. In addition, mold containers 30 are placed in housing 2 while pressure die 18 is in the lower pressure die position P₀ at a lower height hp₀ of lower pressure die position P₀ of about 40 cm starting from a footprint surface 100 of device 1. Pressure die 18 can optionally be moved to any height between lower pressure die position P₀ and cover 12 of housing 2 for loading housing 2 in order to make it easier to load housing 2. With an increasing number of mold containers 30 placed in housing 2, pressure die 18 can then be moved towards lower pressure die position P₀, which represents a starting position of pressure die 18 for the production process, until all mold containers 30 are positioned in housing 2.

Pressure die 18 is moved upwardly in the direction of cover 12 by way of a drive 20 arranged in a bottom region 6 by a driving force F_{A}, starting from a lower pressure die position P₀ in housing 2. In the present embodiment, bottom region 6 is formed by base 6′ of housing 2. Bottom region 6 can optionally be a region that in a vertical direction of device 1 is up to 40 cm, preferably at most 20 cm, more preferably at most 10 cm, away from base 6′ of housing 2. Lower pressure die position P₀ depends upon drive 20 arranged under pressure die 18, in particular its height. In the present case, the height of drive 20 is about 24 cm. Lower pressure die position P₀ in the present embodiment is therefore about 24 cm above base 6′. In addition to a thickness of base 6′ and pressure die 18 as well as a height of rollers 4, lower height hp₀ of lower pressure die position P₀ is approximately 40 cm, starting from a footprint surface 100 of device 1.

A die distance of pressure die 18 is there restricted by stack 32 so that pressure die 18 is moved to an upper pressure die position P₁ which depends upon a height of stack 32 and the portion of food to be processed. Due to this motion, pressure die 18 exerts pressing force F_{P} upon stacks 32 in order to shape the portions of food in mold containers 30 or to produce the food products, respectively.

In FIG. 2b, device 1 is shown at the end of the production process when pressure die 18 has moved upwardly to upper pressure die position P₁ and exerts pressing force F_{P} upon stacks 32. Pressure die 18 moves from lower pressure die position P₀ to upper pressure die position P₁ by a pressure die distance x of approximately 50 cm. In the present embodiment, an upper height hp₁ of upper pressure die position P₁ of pressure die 18 is approximately 90 cm, starting from a footprint surface 100 of device 1. Pressure die 18 can optionally slide by at least 35 cm, preferably by at least 40 cm, and/or by at most 80 cm, preferably by at most 60 cm. Pressing force F_{P} acts upon stacks 32 due to the motion of pressure die 18. Since mold containers 30 are stacked directly on top of one another, the pressure exerted by pressure die 18 upon an uppermost mold container 30 of stack 32, which abuts against cover 12 of housing 2, is transmitted to all mold containers 30 disposed in stack 32.

Drive 20 for pressure die 18 is arranged on base 6′ and is configured to be pneumatic. Drive 20 exerts a driving force F_{A} upon pressure die 18 which is thereby moved to upper pressure die position P₁ and exerts pressing force F_{P} upon stacks 32 during the motion. A pressure for generating driving force F_{A} of drive 20 is detected by way of a sensor (not shown), for example, a pressure gauge, and adjusted by way of a control device (not shown) such that pressure die 18 generates desired pressing force F_{P}. By arranging drive 20 for pressure die 18 on device 1, a separate pressing station is dispensed with.

Pneumatic drive 20 comprises a pneumatic lifting cylinder 21 which is configured as a bellows cylinder. This allows for a resilient, reliable and, ideally, inexpensive drive to be realized. Simple and efficient movement of pressure die 18 is made possible by way of pneumatic lifting cylinder 21. In particular, manual (re-) adjustment of the drive, as is required, for example, with a manually operated spindle drive, can then be dispensed with. It is possible by way of pneumatic drive 20 to generate pressing force F_{P} in a simple and precise manner.

Drive 20 drives pressure die 18 such that it transmits the pressing force F_{P} steplessly to stacks 32. Optionally, pressing force F_{P} can be transmitted stepwise. Pressing force F_{P} to be applied depends upon the portion of food to be processed, in particular its composition.

Drive 20 furthermore comprises a quick coupling 20a which can be connected in a simple manner to a compressed air source (not shown) that is remote from drive 20. This can be particularly advantageous if housing 2 is to be moved to a processing room in which the heat and/or smoke treatment takes place for producing the food product there. Once housing 2 has been placed in the processing room, a compressed air hose can be connected to quick coupling 20a and drive 20 can thus be supplied with compressed air. This eliminates the need to interrupt the production process in order to adjust drive 20. Ideally, the accuracy and/or quality of the food product is improved.

Nine telescopic guide rails 16 are arranged between cover 12 of housing 2 and pressure die 18. They are used to guide pressure die 18, in particular linearly, in housing 2 when it is moved in housing 2. Non-uniform movement of pressure die 18, in particular lateral tilting or canting in housing 2, is thus prevented. It is ensured that pressure die 18 exerts the desired pressing force F_{P} upon stacks 32. This contributes to an almost friction-free and optionally economical process flow. In particular, since several guide rails 16 are provided, the guidance of pressure die 18 is improved over just one guide rail 16. Optionally, more or fewer guide rails 16 can be provided. In the present embodiment, guide rails 16 are arranged in a 3×3 matrix in housing 2 (see FIG. 1). Three guide rails 16 are therefore arranged one behind the other between two stacks 32 each. A distance d of guide rails 16 from one another and from an edge of housing 2 depends upon mold containers 30 or stacks 32, in particular their width b. In the present embodiment, mold container 30 or stack 32, respectively, is approximately 185 mm wide so that distance d is approximately 188 mm, i.e. slightly wider than mold container 30. This allows mold containers 30 to be placed between guide rails 16 in a simple manner.

Guide rails 16 are also used as a lateral stop for stacks 32. This enables simple and precise positioning of stacks 32 within housing 2. In addition, in particular with a motion of pressure die 18, it is prevented that one or more of mold containers 30 of stack 32 tilts and/or turns. Stacks 32 are thus stabilized in housing 2. This also makes it easier to load and empty housing 2, since guide rails 16 serve as a guide for mold containers 30.

Guide rail 16 is attached to cover 12 and pressure die 18 so as to be detachable. This is particularly advantageous for cleaning guide rails 16 and/or housing 2.

FIG. 3 shows a schematic view of a guide rail 16 of a device 1 for producing a food product according to an embodiment. Guide rail 16 comprises a rail housing 16a with a pullout element 16b that can slide therein. Rail housing 16a is connected to cover 12 and pullout element 16b is connected to pressure die 18. Optionally, rail housing 16a can be connected to pressure die 18 and pullout element 16b can be connected to cover 12.

Rail housing 16a has a rail housing inner diameter of about 42 mm and a rail housing wall thickness of two millimeters. Optionally, rail housing 16a can have a rail housing inner diameter of at least about 35 mm, preferably at least about 40 mm. Rail housing 16a can have a rail housing inner diameter of at most about 50 mm, preferably at most about 45 mm. Optionally, rail housing 16a can have a rail housing wall thickness of at least about one millimeter. Rail housing 16a can have a rail housing wall thickness of at most about five millimeters, preferably at most about three millimeters.

Pullout element 16b has a pullout element outer diameter of approximately 35 mm and a pullout element wall thickness of about two millimeters. Optionally, pullout element 16b can have a pullout element outside diameter of at least about 30 mm. Pullout element 16b can have a pullout element outer diameter of at most about 47 mm, preferably at most about 40 mm. Pullout element 16b can optionally have a pullout element wall thickness of at least about one millimeter. Pullout element 16b can have a pullout element wall thickness of at most about five millimeters, preferably at most about three millimeters.

Pullout element 16b is in engagement with rail housing 16a by way of a sliding inner tube, not shown. When pullout element 16b moves relative to rail housing 16a, the sliding inner tube, in particular a sliding surface thereof, can slide on a rail housing inner wall. The sliding inner tube comprises polyoxymethylene (POM) and polytetrafluoroethylene (PTFE). Damage to pullout element 16b and/or rail housing 16a can be prevented. Ideally, friction, vibrations, and/or noise between pullout element 16b and rail housing 16a can be reduced. The sliding inner tube is attached to pullout element 16b so as to be detachable. In the present embodiment, the sliding inner tube is fastened with a screw to an internal thread of pullout element 16b. The sliding surface is about 100 mm. The sliding surface can optionally be at least about 50 mm, preferably at least about 60 mm, long. The sliding surface can be at most about 120 mm, preferably at most about 90 mm, long.

Pullout element 16b can slide out of rail housing 16a or into rail housing 16a by at a maximum rail distance wₘₐₓ of almost 75 cm. In the present embodiment, the maximum rail distance corresponds approximately to a length of pullout element 16b. In a state in which pressure die 18 is in lower pressure die position P₀, pullout element 16b is moved out of rail housing 16a by at most the maximum rail distance wₘₐₓ. If pressure die 18 moves from lower pressure die position P₀ to upper pressure die position P₁ by pressure die distance x of 50 cm, then pullout element 16b is moved into rail housing 16a by a distance x′ corresponding to pressure die distance x.

Guide rails 16 are formed to be seamless. This enables pullout element 16b to be moved uniformly into or out of rail housing 16a. In addition, this improves the guidance of pressure die 18 so that in particular lateral tilting or canting of pressure die 18 in housing 2 is as good as prevented and, ideally, a uniform and in particular almost jerk-free motion of pressure die 18 is made possible. This improves the quality of the food product produced.

The above description is that of current embodiment of the invention. Various alterations and changes can be made without departing from the spirit and broader aspects of the invention. This disclosure is presented for illustrative purposes and should not be interpreted as an exhaustive description of all embodiments of the invention or to limit the scope of the claims to the specific elements illustrated or described in connection with these embodiments. Any reference to elements in the singular, for example, using the articles “a,” “an,” “the,” or “said,” is not to be construed as limiting the element to the singular.

1. A device for producing a food product from a portion of food, said device comprising:
a housing which is open on at least one side for receiving a plurality of separate mold containers which are arranged directly on top of one another in at least one stack and can each be filled with a portion of food;
at least one drive arranged in a bottom region of said housing for driving a pressure die which is mounted in said housing so as to be slidable in the direction of said stack for exerting a pressing force upon said stack; and
at least one telescopic guide rail arranged between a cover of said housing and said pressure die for guiding said pressure die in said housing.

2. The device according to claim 1, wherein two or more guide rails are provided.

3. The device according to claim 1, wherein said telescopic guide rail is configured to be seamless.

4. The device according to claim 1, wherein said telescopic guide rail is configured as a lateral stop for said stack.

5. The device according to claim 1, wherein said pressure die or said telescopic guide rail is slidable by at least 35 cm.

6. The device according to claim 1, wherein said drive comprises a pneumatic, hydraulic, or electric lifting cylinder.

7. The device according to claim 1, wherein said housing is formed by a rack that is open on several sides.

8. The device according to claim 1, wherein said housing is configured to receive several stacks arranged next to one another.

9. The device according to claim 1, wherein said housing is movable.

10. A method producing a food product from a portion of food using a device according to claim 1.
